(19) United States
(12) Patent Application Publication
(10) Pub. No.: US 2005/0066687 A1
(43) Pub. Date: Mar. 31, 2005

(54) Methods for the production of marble-like crystallized glass panel wih embossed surface

(75) Inventor: Chi-Fu Tito Hsueh, Escondido, CA (US)

Correspondence Address: CHI-FU HSUEH, 2275 MONTIA PLACE, ESCONDIDO, CA, 92029, US

(73) Assignee: Mr. Chi-Fu Tito Hsueh, Escondido, CA (US)

(21) Appl. No.: 10/605,453

(22) Filed: Sep. 30, 2003

(51) Int. Cl. C03C 10/10

(52) U.S. Cl. 65/33.6; 65/33.7

(57) ABSTRACT

Methods of producing crystallized glass panel (or the same) having an embossed surface to a regular or irregular pattern, thereby producing a stereoscopic aspect and a less slippery surface. In a crystallized glass article consisting of crystallized glass particles (bits or pieces) fusion bonded together, the thickness of the article can be determined by the density of glass particles packed in the mold. Therefore, by preparing different size of glass particles in the mold in different areas can produce glass article with various thickness and result un-even surface. Moreover, in controlling the process of flow deformation can produce glass article with embosses surface. The glass particles can be SiO₂—Al₂O₃—CaO, SiO₂—Al₂O₃—CaO—ZnO, or any other crystallizable glass.

### CROSS REFERENCE TO RELATED APPLICATIONS

U.S. Pat. No. 3,554,725 January/1971 Bracken et al.

G.B.142779201/1972 Nippon Electric Glass

U.S. Pat. No. 3,672,859 June/1972 Claussen

U.S. Pat. No. 3,843,343 October/1974 Okada et al.

U.S. Pat. No. 3,955,989 May/1976 Nakamura

U.S. Pat. No. 4,054,435 October/1977 Sakane et al.

U.S. Pat. No. 4,746,347 May/1988 Sensi

U.S. Pat. No. 5,089,345 February/1992 Hashibe et al.

U.S. Pat. No. 5,403,664 April/1995 Kurahashi et al.

U.S. Pat. No. 5,885,315 March/1999 Fredholm et al.

### BACKGROUND OF INVENTION

This invention relates to the process of producing flat crystallized glass panel with embossed surface which results stereoscopic aspect and better static friction on the surface to prevent from slipping under wet condition, so it can better be used on floor application and others.

### DISCUSSION OF PRIOR ART

Crystallized glass has been utilized in the manufacturing of such varied articles as cookware, tableware, missile nose cones, protective shields, and in the computer and electronics field. Nowadays, crystallized glass has been used as ornamental building materials to replace the natural stones due to its excellent characteristics in mechanical strength, heat-resistance, chemical corrosion strength, and water resistance, and has obtained great popularity. However, its glossy and smooth surface together with its pure color often creates simple and cold environmental feelings. Several patents (G.B. 1427792, 1972; U.S. Pat. No. 3,843,343, 1974, Okada et al.; U.S. Pat. No. 3,955,989, 1976, Nakamura; U.S. Pat. No. 5,403,664, 1995, Kurahashi et al.) disclose the methods of producing surface pattern over crystallized glass flat panel. However, these methods are limited in changing the color pattern of the surface rather than the roughness of the surface. As a result, the crystallized glass has inherited the smooth and glossy characteristic of glass and has limited its use from floor application due to the potential risk of slip.

The U.S. Pat. No. 5,089,345, 1992, Hashibe et al. states that it is uneconomical to apply molds with rough and uneven surface to produce crystallized glass with uneven surface, and discloses a method of producing crystallized glass with an irregular rough surface pattern. However, the rough surface is produced by overlapping flaky and flattened crystallized pieces at “random” at the bottom of the glass article. The resulted surface is therefore unpredictable.

Many U.S. Patents (U.S. Pat. No. 3,554,725, 1971, Bracken et al.; U.S. Pat. No. 3,672,859, 1972, Classen; U.S. Pat. No. 4,746,347, 1988, Sensi; U.S. Pat. No. 5,885,315, 1999, Fredholm et al.) disclose methods of using molten glass to form glass sheets with rough surface patterns through mechanical rollers. However, the process is not adequate for producing marble-like crystallized glass.

### OBJECTS AND ADVANTAGES

The main objective of the present invention relates to marble-like crystallized glass articles is to provide methods to produce a regular or irregular embossed surface.

The present invention that produces crystallized glass with regular or irregular embossed surfaces can increase the static friction of its surface over 20%, comparing to the traditional smooth surface, to better prevent from slipping under wet conditions.

The present invention that produces crystallized glass with regular or irregular embossed surface can create a stereoscopic aspect with less mirror-like light reflection to provide better visual comfort.

The present invention that produces crystallized glass with regular or irregular embossed surface has uniform, predictable and consistent surface pattern.

The present invention requires no additional tools. It is accomplished by controlling the crystallizing temperature profile and the Molding procedures over various sizes of glass particles.

The present invention is cost effective and economically ideal for mass production.

### SUMMARY OF INVENTION

The crystallized glass is an ideal substitution of natural stone as ornamental building materials because of its superior mechanical strength, heat resistance, and efflorescence resistance. In general, all flat or curved crystallized glass articles have glossy and smooth surface, and therefore have very limited application on floor due to the potential risk of slip.

Crystallizable glass can be obtained by heating the special formulated, mixed raw materials of glass at a temperature of over 1400° C. The molten glass is water granulated into glass granules. During the crystallizing process, glass granules are softened, deformed and fusion-bonded together along their interfaces. Along with the desired temperature profile, the β-type needle-like crystals are formed from the surface of the glass granules toward the interior (crystallization). In completion of the crystallization, the integral crystallized glass article is obtained (G.B. 1427792, 1972; U.S. Pat. No. 3,843,343, 1974, Okada et al.; U.S. Pat. No. 3,955,989, 1976, Nakamura; U.S. Pat. No. 4,054,435, 1977, Sakane et al.; U.S. Pat. No. 5,403,664, 1995, Kurahashi et al.).

The present invention relates to a process of producing crystallized glass, requires no special molds, consists of six general steps:

(1) Molten glass materials: Crystallizable glass of the systems SiO₂—Al₂O₃—CaO or SiO₂—Al₂O₃—CaO—ZnO, or others may be employed. The formulated glass materials are heated at 1400 1600° C.

(2) Water granulation: The molten glass (1) is granulated in water into glass particles with less than 10 mm in size. The ideal water temperature is around 40-60° C. The granulated glass particles are collected and dried.

(3) Molding: The granulated glass particles are loaded on a flat refractory mold with surrounding frames. The top surface of the mold and interior surfaces of the frames are coated with a mold release agent (Al₂O₃ powder or others).

(4) Crystallizing: During heat-treated process, glass granules are softened, deformed and fusion-bonded together along their interfaces. Along with the desired temperature profile, the β-type needle-like crystals are formed from the surface of the glass granules toward the interior (crystallization). In completion of the crystallizing process, the integral crystallized glass article is obtained.

(5) Flow deformation: At liquefied temperature, the flow deformation is formed and advanced on the surface of glass article to fill up the space among glass particles to produce a smooth and even surface.

(6) Cooling: A proper temperature profile is applied for cooling, so the glass article will not crack or distort.

The original crystallized glass articles and natural stone, such as marble or granite, have a polished, smooth, and glossy surface. The present invention is to produce the crystallized glass with embossed surface. It creates a stereoscopic aspect over the surface for better visual comfort and increases static friction to prevent from slipping under wet conditions. The invention requires no additional tools but various process techniques. It is cost effective and easy to be adopted for mass production.

It is possible to produce a rough surface of the glass articles by overlapping crystallizable glass pieces at the bottom of the mold and uses it as principal surface (ref U.S. Pat. No. 5,089,345). However, the surface condition is hard to predict and is not adequate for mass production.

The present invention provides two different methods in producing crystallized glass with an embossed or un-even surface.

Method 1: to control the flow deformation process to obtain the embossed surface (FIGS. 1a-1c).

Method 2: to load the glass particles with both glass bits and pieces to create the variation of the density of the glass body, so as to produce an uneven surface (FIG. 2a 2f).

### BRIEF DESCRIPTION OF DRAWINGS

FIG 1a illustrates that the glass body is prepared by loading various sizes of glass particles into the mold and ready for crystallization process.

FIG 1b illustrates that the flow deformation smoothes the surface.

FIG 1c illustrates that to control the flow deformation in effect creates a non-smoothed surface.

FIGS. 2a & 2b are diagrams that illustrate the thickness of glass body before and after the crystallization process.

FIGS. 2c & 2d are diagrams that illustrate the thickness of glass body, before and after crystallization process, which mixes the glass bits with flat glass pieces together.

FIG. 2e illustrates the method of loading the glass particles with both glass bits and glass pieces.

FIG. 2f illustrates the result of the crystallized glass panel with an uneven surface of 2e.

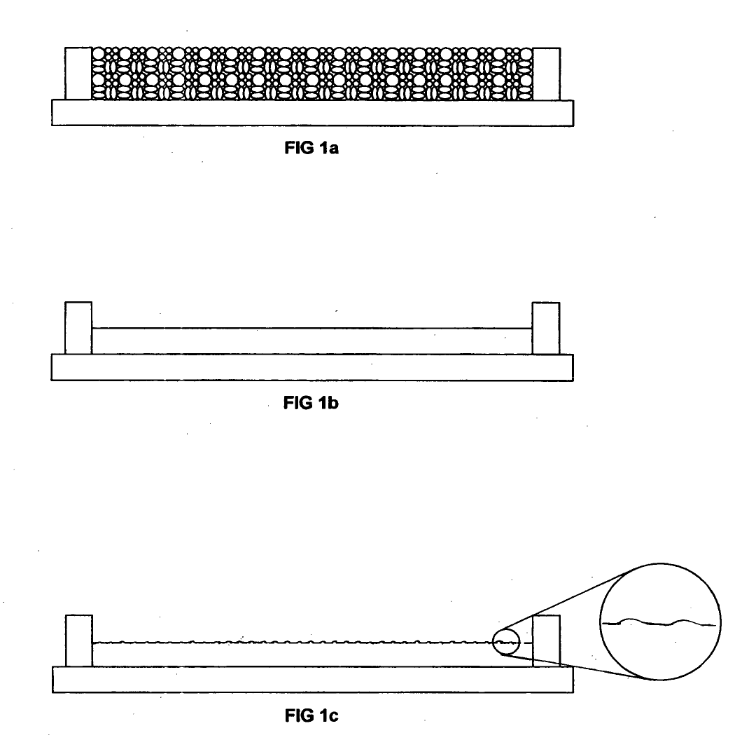

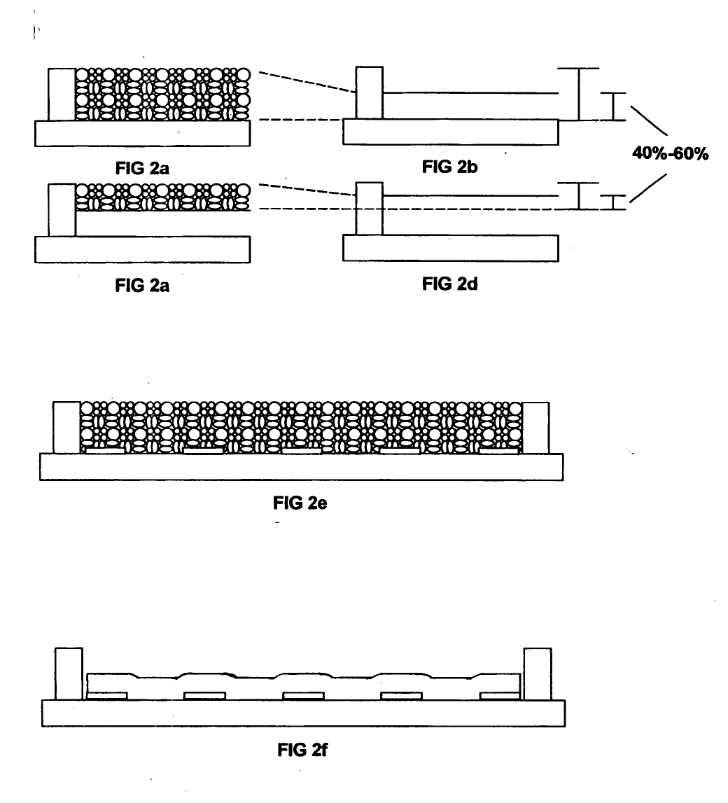

### DETAILED DESCRIPTION

Method 1: The crystallized glass articles are commonly produced with a smoothed surface. The crystallizing process requires the glass body to be at a temperature where the flow deformation is advanced in order for the surface to be totally smoothed out. It is suggested in the previous patents (ref. Patents G.B. 1427792, U.S. Pat. No. 3,843,343, U.S. Pat. No. 3,955,989, U.S. Pat. No. 4,054,435) that to keep the glass body at about 1150° C. for one hour to complete the crystallizing and flow deformation processes. It is our invention to control the flow deformation process, so the spaces among glass particles are filled with glass flow, but the glass particles are not completely flattened down. To do so, we divide the procedure into two steps as follows:

1) keep the glass body at a temperature lower than the temperature that the flow deformation process needs (about 20° C. below) for a period of time, then

2) raise up the temperature to where the flow deformation process requires for time as needed.

The first step of process provides enough time for the crystals to grow within the glass body. It also prepares the glass body in temperature close to the flow deformation process needs, so the flow can happen quickly as soon as the temperature rises. In step two, we control the time factor of the process to obtain the desired surface condition as we needed. It is important to know that the formula of glass, the size of the glass particles, the type of furnace used, and the required deviation in depth over the surface are all important factors in determining those temperature and time parameters. The basic procedure is as follows:

1. To prepare crystallizable glass bits with size of 10 mm or less.

2. Apply mold release agent over the refractory mold and frames to prevent the glass from adhering on the mold during the crystallization.

3. Putting the glass bits in 1) into the mold over the mold release agent and leveling the surface.

4. Place the mold into furnace for heat-treatment.

5. ln conjunction with the crystallizing process, kept the glass body at about 20° C. below the temperature of flow deformation process for a period of time, so the crystals are formed inside the glass bits and the glass bits are all fusion-bonded together

6. Kept the glass body at the temperature where the flow deformation process requires for a period of time as desired.

7. Polishing the surface as desired and to remove sharp bumps.

Method 2: The thickness of the crystallized glass article is usually about 40% 60% (depends upon the size of particles) of the height of the glass body before it is crystallized, This is due to the fact that different size of glass particles, after fusion bonded together, produces different porous body, and therefore results different density of the article (ref U.S. Pat. No. 4,054,435). On the other hand, the density of the glass body varies the thickness of the glass article. It is our invention to load the glass body with different glass particles, so it has different density in different locations among the glass body. Controlling the time of flow deformation process can produce crystallized glass panel with un-even surface. The basic procedure is as follows:

1. To prepare crystallizable glass bits with size of 5 mm or less.

2. To prepare flat crystallizable/crystallized glass pieces with thickness and shapes desired (circle, square, hex, etc . . . ).

3. Apply mold release agent over the refractory mold and frames to prevent the glass from adhering on the mold during the crystallization.

4. Place the flat glass pieces prepared in 2) on the mold over the mold release agent in position desired.

5. Fill up the mold with glass bits prepared in 1). The glass bits may/may not cover the surface of the glass pieces.

6. Place the mold into furnace for heat-treatment.

7. ln conjunction with the crystallizing process, kept the glass body at about 20° C. below the temperature of flow deformation process for a period of time, so the crystals are formed inside the glass bits and the glass bits are all fusion-bonded together

8. Kept the glass body at the temperature where the flow deformation process requires for a period of time or as desired.

9. Polishing the surface for desired finishing.

### EXAMPLES

The crystallizable glass bits used is within SiO₂—Al₂O₃—CaO—ZnO. The size of the mold is around 1000 mm×1000 mm. The refractory mold is coated with Al₂O₃ to prevent the glass from adhering on the mold during the crystallization.

### Example 1

Two sizes of crystallizable glass bits are used, one with size between 3-5 mm (type A) and another with size 3 mm or less (type B). Load 25 kg glass bits of type B into the mold over the mold release agent and level the surface. Load another 25 kg glass bits of type A into mold over the glass bits previously loaded. Leveling the surface. Place the mold into furnace and follow its regular temperature profile for heat-treatment. Maintain the temperature to 1115° C. for 40 minutes. The crystals are then formed inside the glass bits and the glass bits are all fusion-bonded together. Maintain the temperature to 1135° C. for 30 minutes. In completion of cooling process, polish the surface as desired. The polished article has craters on surface uniformly with average size >5 mm and depth of 0.2 0.5 mm.

### Example 2

The crystallizable glass bits with size of 3 mm or less and flat crystallized glass pieces with size of 30 mm×30 mm and thickness of 3 mm are used. The flat glass pieces are placed on the mold over the mold release agent with 100 mm apart. Load 50 kg glass bits into the mold over flat glass pieces and level the surface. Place the mold into furnace and follow its regular temperature profile for heat-treatment. Maintain the temperature to 1115° C. for 40 minutes. The crystals are then formed inside the glass bits and the glass bits are all fusion-bonded together. Maintain the temperature to 1135° C. for 30 minutes. In completion of cooling process, polish the surface as desired. The polished article has square shaped bumps on surface uniformly with average size <30 mm and depth <1.2 mm.

1. A method of producing an embossed crystallized glass article, comprising the steps of: Preparing small size of crystallizable glass bits, each of said bit having a property that when heat-treated at certain temperature, needle-like β-wollastonite crystals are formed, said crystals extending from the surface into the interior of the glass body. Packing the said glass bits into mold to form a layer. Heat-treating the said glass article, so all the individual small glass bits being fusion-bonded along. Each of said fusion-bonded small glass bits having needle-like β-wollastonite crystals extending from the surface into the interior of the glass body. Heat-treating the said glass article at liquidus temperature, so the liquidated glass flow on the surface would fill in all spaces among fusion-bonded glass bits. Stop the process before the glass bits on the surface are completely flattened down. Polishing the finished glass article to remove sharp bumps and results embossed surface pattern.

2. The crystallized glass article claimed in claim 1, wherein said glass bits of crystallizable glass consist essentially of SiO₂, Al₂O₃, and CaO.

3. The crystallized glass article claimed in claim 1, wherein said glass bits of crystallizable glass consist essentially of SiO₂, Al₂O₃, CaO, and ZnO.

4. The crystallized glass article claimed in claim 1, wherein said glass bits of crystallizable glass have size of less than 10 mm.

5. The crystallized glass article claimed in claim 1, wherein said heat-treating at liquidus temperature for only limited time, so all spaces among glass particles are filled in by the glass flow but the glass bits on the surface are not completely flatten down.

6. The crystallized glass article claimed in claim 1, wherein said polishing is to remove limited top portion of bumps.

7. A method of producing an un-even crystallized glass article, comprising the steps of: Preparing small size of crystallizable glass bits, each of said bit having a property that when heat-treated at certain temperature, needle-like β-wollastonite crystals are formed, said crystals extending from the surface into the interior of the glass body, and flat crystallizable/crystallized glass pieces. Packing the said glass bits and pieces into mold to form a layer by placing the flat glass pieces on the mold over the mold release agent then fill up with glass bits. The glass bits may/may not cover the surface of the glass pieces. Heat-treating the said glass article, so all the individual small glass bits and glass pieces being fusion-bonded. Each of said fusion-bonded small glass bits and glass pieces having needle-like β-wollastonite crystals extending from the surface into the interior of the glass body. Heat-treating the said glass article at liquidus temperature, so the liquidated glass flow on the surface would fill in all spaces among fusion-bonded glass bits. Stop the process before the surface of the glass article is completely even. Polishing the finished glass article for smooth or embossed un-even surface.

8. The crystallized glass article claimed in claim 7, wherein said glass bits of crystallizable glass consist essentially of SiO₂, Al₂O₃, and CaO.

9. The crystallized glass article claimed in claim 7, wherein said glass bits of crystallizable glass consist essentially of SiO₂, Al₂O₃, CaO, and ZnO.

10. The crystallized glass article claimed in claim 7, wherein said glass pieces have certain thickness and are not limited to be any form of glass materials as long as its density do not change in process.

11. The crystallized glass article claimed in claim 7, wherein said glass bits of crystallizable glass have size of less than 10 mm.

12. The crystallized glass article claimed in claim 7, wherein said heat-treating at liquidus temperature for only limited time, so all spaces among glass particles are filled in by the glass flow and the surface of the glass article is not completely even.

13. The crystallized glass article claimed in claim 7, wherein said polishing is to produce either smooth or embossed un-even surface of the glass article.
